(19) United States
(12) Patent Application Publication
(10) Pub. No.: US 2018/0368385 A1
(43) Pub. Date: Dec. 27, 2018

(54) ILLUMINATED INSECT TRAP WITH ANGLED GLUEBOARD

(71) Applicant: Gilbert Industries, Inc., Jonesboro, AR (US)

(72) Inventor: David Wesley Gilbert, II, Jonesboro, AR (US)

(73) Assignee: Gilbert Industries, Inc., Jonesboro, AR (US)

(21) Appl. No.: 15/631,382

(22) Filed: Jun. 23, 2017

(51) Int. Cl. A01M 1/14

(52) U.S. Cl. CPC A01M 1/145; A01M 2200/012; A01M 1/14

(57) ABSTRACT

A flying insect trap that has a housing with a rear wall and a front opening opposite the rear wall with a housing interior therebetween, and a glueboard mounted in said housing interior, said glueboard being elevated a distance above a bottom wall of the housing and being oriented with a rear edge of said glueboard being lower than a front edge of said glueboard so as to form an acute angle with the rear wall of the housing.

### BACKGROUND OF THE INVENTION

### Field of the Invention

The present invention concerns a trap for flying insects of the type having a light source inside the trap that attracts flying insects into the trap, and a glueboard situated in the trap to which the flying insects are adhered upon alighting on the glueboard.

### Description of the Prior Art

Traps for flying insects are generally known that have a housing with an open front, with one or more light sources, such as fluorescent lamps, inside of the housing that produce light at a wavelength or wavelength range that is known to attract certain flying insects. Such traps also have one or more glueboards situated inside of the housing. The glueboards are coated on at least one surface thereof with an adhesive material so that when flying insects attracted by the light sources alight on each glueboard, the flying insects become adhered to the glueboard.

The glueboards are removably mounted within the housing so that as trapped insects accumulate thereon, a glueboard that is currently in use can be removed from the housing, and replaced with clean glueboard.

An example of a commercially available flying insect trap of this type is the Sticky Fox™ that is manufactured and sold by Gilbert Industries. This commercially available trap has a generally rectangular box-like housing, with an open front that is covered by a hinged grill. The grill has horizontal bars with openings therebetween, so that when the grill is closed at the front of the housing, flying insects can still access the interior of the housing through the openings in the grill.

The housing of this known trap has an upwardly angled bottom wall, on which a glueboard can be placed, so that the glueboard is then also upwardly angled, and is resting on and adjacent to the bottom wall. The rear wall of the housing has a clip at an upper region thereof, in which the edge of another glueboard can be inserted and held, so that this further glueboard is adjacent to the back wall of the housing. The sidewalls of the housing have horizontally extending pegs projecting therefrom, so that a third glueboard can be inserted generally in the middle of the housing, so as to be oriented flat and horizontal within the housing, perpendicular to the rear wall of the housing.

The hinged mounting of the grill allows the grill to be opened upwardly by pivoting around the hinge, so that the interior of the trap is then accessible, allowing each of the aforementioned glueboards to be replaced, when necessary.

### SUMMARY OF THE INVENTION

An object of the present invention is to provide a glueboard-type flying insect trap of the general type described above, wherein the number of trapped insects, or the trapping rate, is improved.

The above object is achieved in accordance with the present invention in a flying insect trap of the type generally described above, that is provided with a glueboard that is elevated above the bottom wall of the housing, and wherein this elevated glueboard is mounted so as to be at an upwardly proceeding angle from the back wall of the housing of the trap toward the open front of the trap housing.

As used herein, “elevated” means that at least the glueboard is situated in the trap housing so as to be at a vertical distance that is higher than the bottom edge of the front opening frame of the trap housing.

This orientation of the glueboard that is spaced from the bottom of the trap housing means that the rear edge of the glueboard, which is closest to the rear wall of the housing, is lower than the opposite front edge of the glueboard, which is closest to the open front of the trap housing.

Preferably, this elevated glueboard is oriented at an angle of approximately 45 degrees relative to the rear wall of the housing.

In an embodiment of the invention, the flying-insect-attracting light source is formed by two horizontally proceeding fluorescent lamps, and the upwardly proceeding glueboard is mounted in the housing between those two horizontally proceeding lamps.

The housing of the flying insect trap in accordance with the invention may have a bottom wall that also proceeds upwardly from the rear to the front of the housing, and, as is conventional, a further glueboard may be situated on this bottom wall of the housing. The bottom wall of the housing, and thus the further glueboard situated thereon, may proceed at the same angle from the rear of the housing as the aforementioned elevated upwardly proceeding glueboard.

As is also known, another glueboard may be clipped to the rear wall of the housing, so as to be adjacent to the rear wall, and thus the elevated upwardly proceeding glueboard will also proceed at an upwardly extending angle from this rear wall-mounted glueboard.

Any combination of these further glueboards may be used together with the elevated upwardly projecting glueboard, so that the insect trap has a combination of two or three glueboards, but always including the elevated upwardly proceeding glueboard.

By providing such an elevated upwardly proceeding glueboard, in contrast to the conventional horizontally proceeding glueboard that is mounted at such an elevated location relative to the bottom wall of the housing, the angled, upwardly proceeding glueboard in accordance with the present invention provides a larger surface area compared to the horizontal glueboard, because the back-to-front dimension of the upwardly proceeding glueboard is longer than the back-to-front dimension of a horizontal glueboard, but the side-to-side dimensions of these two different glueboards are the same, and therefore the total surface area that is covered with adhesive material of the upwardly proceeding glueboard in accordance with the present invention is larger than the adhesive material area of a horizontal glueboard. The back-to-front dimension of a conventional horizontal glueboard is constrained to be no larger than the back-to-front dimension of the trap housing, but the upwardly proceeding elevated glueboard in accordance with the invention has a back-to-front dimension that is larger than the back-to-front dimension of the housing.

### BRIEF DESCRIPTION OF THE DRAWINGS

FIG. 1 is a front view of a flying insect trap in accordance with the present invention.

FIG. 2 is a sectional view along line A-A in FIG. 1, of the flying insect trap with no glueboards therein.

FIG. 3 is a sectional view, along line A-A of FIG. 1, of an embodiment of the flying insect trap in accordance with the invention with a glueboard on the bottom housing wall and with the elevated, upwardly projecting glueboard removed.

FIG. 4 is a sectional view along line A-A of FIG. 1 of an embodiment of the present invention having the elevated, upwardly angled glueboard by itself.

FIG. 5 is a sectional view along line A-A of FIG. 1 of an embodiment of the invention having the elevated, upwardly angled glueboard together with a glueboard on the bottom housing wall.

FIG. 6 is a sectional view along line A-A of FIG. 1 of an embodiment of the invention having the elevated, upwardly angled glueboard together with a glueboard on the bottom housing wall and a glueboard on the back housing wall.

### DESCRIPTION OF THE PREFERRED EMBODIMENTS

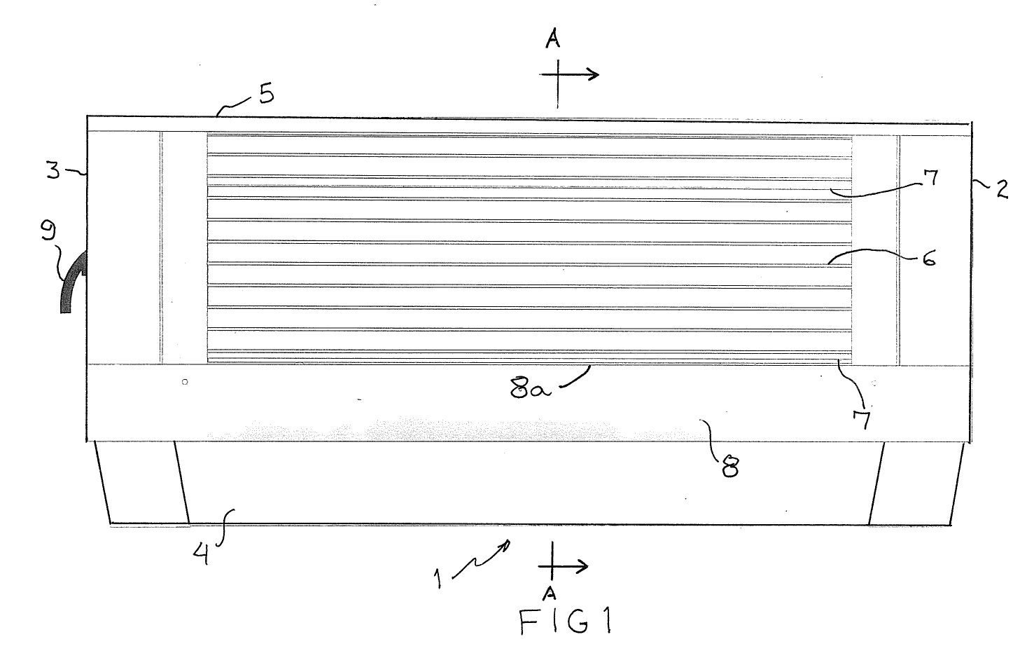

A flying insect trap in accordance with the invention is shown in a front view in FIG. 1. The flying insect trap has a housing 1, with side walls 2 and 3, a bottom wall 4 (which in this embodiment is upwardly angled), and top wall 5. The side walls 2 and 3, the bottom wall 4 and the top wall 5 frame an opening at the front of the trap, which is covered by a grill 6 that is mounted by hinges (not shown) so that when lifted upwardly by a panel 8 attached to the grill 6, the front assembly of the trap pivots around the hinges, so as to provide access to the interior of the housing 1. The panel 8 has a top edge 8a that forms the bottom edge of the front opening frame. Two light sources 7 can be seen through the openings in the grill 6, which in this embodiment are formed by fluorescent lamps. Power to these light sources 7 is provided via an electrical cord 9.

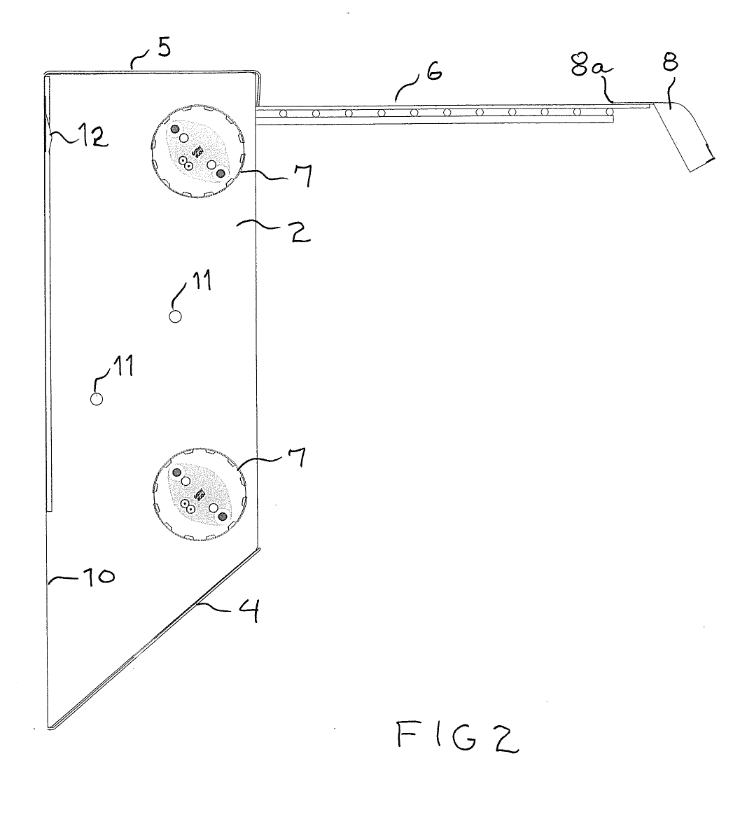

All of the embodiments of the invention shown in FIGS. 2 through 6, discussed below, are sectional views along line A-A shown in FIG. 1, looking toward the side wall 2.

FIG. 2 shows the trap with the grill 6 lifted upwardly, but with no glueboards inserted therein. As can be seen in FIG. 2, in the interior of the housing are pegs 11 that project from the side wall 2. Correspondingly situated pegs also protrude at the same locations from the side wall 3. At the rear wall 10 of the housing, a clip 12 is provided near the top wall 5.

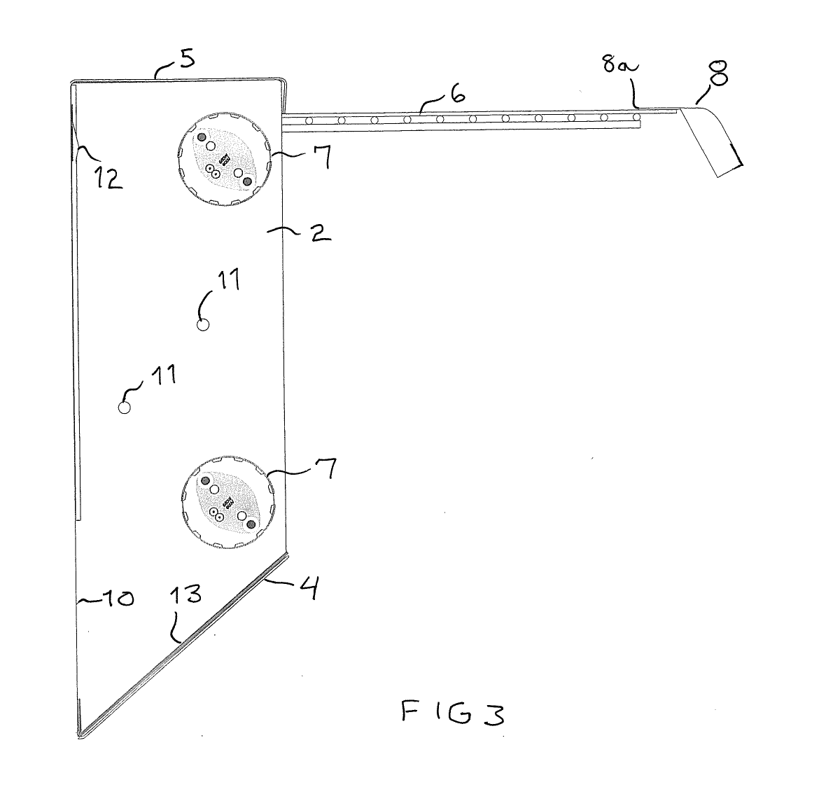

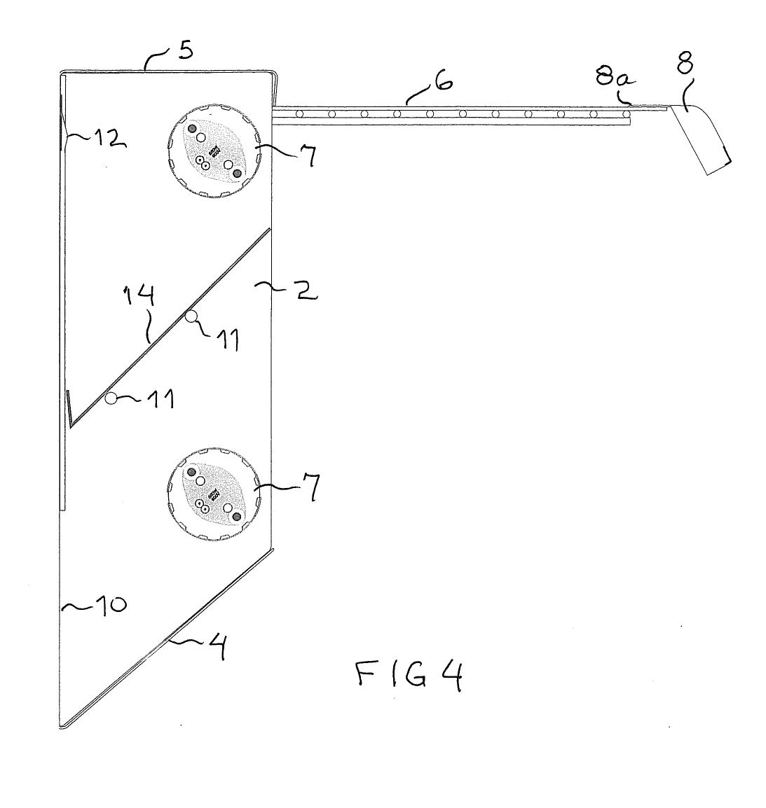

FIG. 3 shows the trap according to the invention with one glueboard 13 placed in the conventional position on the bottom wall 4. FIG. 4 shows the trap with an elevated, upwardly projecting glueboard 14 inserted into the interior of the housing 1, and resting on the pegs 11 on the side wall 2. The glueboard 14 also rests on the similarly situated pegs on the opposite side wall 3. As can be seen in FIG. 4, the rear edge of the glueboard 14, which is closest to the rear wall 10 of the housing, is lower in height than the front edge, which is at the opening of the housing 1. The upper surface of the glueboard 14, facing toward the top housing wall 5, is covered with an adhesive material (not specifically shown) in a known manner so that when flying insects alight thereon they become adhered to the glueboard 14.

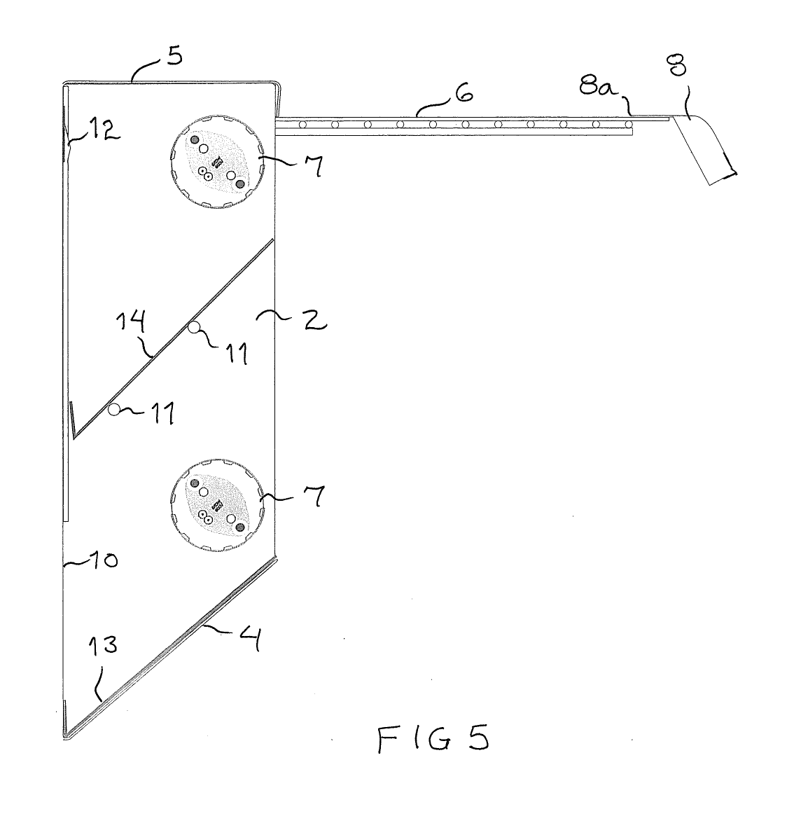

FIG. 5 shows an embodiment that includes both the glueboard 13 and the glueboard 14. As can be seen, the angle that the glueboard 14 makes with the rear wall 10 is the same as the angle that the bottom wall 4 makes with the rear wall 10, but this need not necessarily be the case.

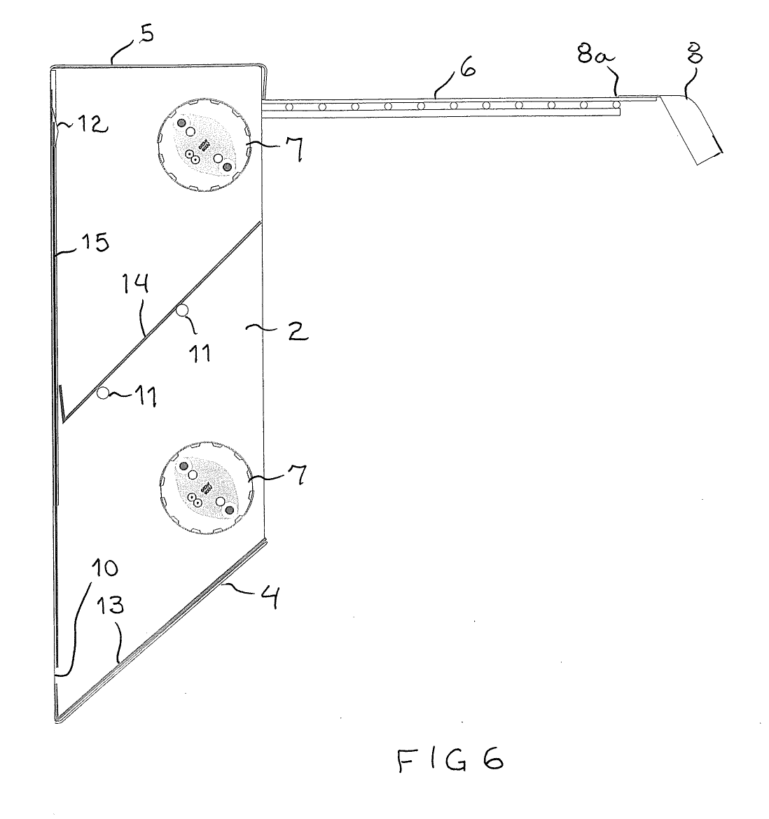

In the embodiment of FIG. 6, a further glueboard 15 has been inserted into the clip 12, and is it held in place by the clip 12 against the rear wall 10 of the housing. The embodiment of FIG. 6 thus has three glueboards in the interior of the trap, namely glueboard 13, glueboard 14 and glueboard 15.

It can be seen that in all embodiments, the elevated glueboard 14 is situated at a vertical height in the housing 1 that is higher than the bottom edge 8a of the front opening frame of the trap housing 1

Although modifications and changes may be suggested by those skilled in the art, it is the intention of the Applicant to embody within the patent warranted hereon all changes and modifications as reasonably and properly come within the scope of the Applicant's contribution to the art.

1. A flying insect trap comprising:
a housing having a rear wall with a top wall, two side walls, and a bottom wall attached thereto and thereby forming a housing interior that is open at a front of said housing opposite said rear wall;
a flying insect-attracting light source in said housing interior;
a glueboard mounted in said housing between said side walls elevated above said bottom wall, with a rear edge of said glueboard, next to said rear wall of said housing, being vertically lower than a front edge of said glueboard at said opening; and
said glueboard having a top surface, which faces upwardly in said housing interior, with an adhesive coating thereon.

2. A flying insect trap as claimed in claim 1 comprising a further glueboard in said housing interior resting on said bottom wall.

3. A flying insect trap as claimed in claim 1 wherein said rear wall of said housing has a clip mounted thereon below said top wall, and comprising a further glueboard held in said clip against said rear wall in said housing interior.

4. A flying insect trap as claimed in claim 1 wherein said glueboard is a first glueboard, and wherein said flying insect trap comprises:
a second glueboard resting on said bottom wall in said housing interior; and
a third glueboard mounted against said rear wall in said housing interior.

5. A flying insect trap as claimed in claim 1 comprising a hinged grill that covers said opening and that is pivotable to provide access to said housing interior.

6. A flying insect trap as claimed in claim 1 wherein said light source comprises at least one florescent lamp mounted horizontally in said housing interior.

7. A flying insect trap comprising:
a housing comprising a rear wall and an open front and a housing interior between said rear wall and said open front;
two flying insect-attracting florescent lamps mounted parallel to each other in said housing interior and proceeding horizontally with a spacing therebetween; and
a glueboard mounted in said housing interior in said spacing between said florescent lamps, said glueboard having a rear edge next to said rear wall of said housing that is vertically lower than a front edge of said glueboard at said opening.

8. A flying insect trap comprising:
a housing having a rear wall and a front opening with a housing interior between said rear wall and said front opening;
said housing comprising a bottom wall attached to said rear wall and angled upwardly relative to said rear wall at an acute angle; and
a glueboard mounted in said housing interior, elevated vertically above said bottom wall and also forming said acute angle with said rear wall.
